(19) United States
(12) Patent Application Publication
(10) Pub. No.: US 2019/0168667 A1
(43) Pub. Date: Jun. 6, 2019

(54) LIGHT GUIDE MEMBER, VEHICLE ILLUMINATION DEVICE, AND METHOD FOR MANUFACTURING LIGHT GUIDE MEMBER

(71) Applicant: YAZAKI CORPORATION, Tokyo (JP)

(72) Inventor: Kazuya SATO, Shizuoka (JP)

(73) Assignee: YAZAKI CORPORATION, Tokyo (JP)

(21) Appl. No.: 16/205,782

(22) Filed: Nov. 30, 2018

(30) Foreign Application Priority Data
Dec. 4, 2017 (JP) 2017-232392

(51) Int. Cl. B60Q 3/64; B60Q 3/217; B60Q 3/54; F21V 8/00

(52) U.S. Cl. CPC B60Q 3/64; B60Q 3/217; B60Q 2500/10; G02B 6/0038; G02B 6/0065; B60Q 3/54

(57) ABSTRACT

A light guide member includes: a light guide member body made of a light transmissive material; a white back surface white-coated layer provided on a back surface of the light guide member body; a white front surface white-coated layer provided on a front surface of the light guide member body; and a black front surface black-coated layer provided on a front surface of the front surface white-coated layer. A light irradiation hole which is opened in the front surface black-coated layer and the front surface white-coated layer and through which the light guide member body is exposed is provided.

### BACKGROUND

### Technical Field

The present invention relates to a light guide member, a vehicle illumination device, and a method for manufacturing a light guide member.

### Related Art

Vehicle illumination devices (direct illumination and indirect illumination) are attached to various parts of a vehicle. One of such vehicle illumination devices using a light guide member is proposed (JP 2010-83211 A).

### SUMMARY

The vehicle illumination device using the light guide member includes an LED light source and the light guide member to which light from the LED light source is incident from one end face. The LED light source and the light guide member are arranged between the inner member such as a bezel and a design member which is a design surface. A reflection plate is arranged on a side of a back surface of the light guide member. A light irradiation hole is formed in the design member.

The light from the LED light source is incident on the light guide member, and the light incident on the light guide member advances inside the light guide member while being reflected by the reflection plate or the like, and is emitted to the outside through the light irradiation hole.

Meanwhile, since the reflection plate has approximately the same degree of thickness as the light guide member, the total thickness becomes twice the thickness of the light guide member.

Moreover, it is also necessary to arrange the design member that forms the light irradiation hole on a side of a front surface of the light guide member so that the total thickness further increases if a thickness corresponding to the design member is added. Thus, there is a demand for forming the light guide member to be thin.

The invention has been made to solve the above-described problem, and an object thereof is to provide a light guide member having a structure as thin as possible, a vehicle illumination device using a light guide member, and a method for manufacturing a light guide member.

A light guide member according to a first aspect of the invention includes: a light guide member body made of a light transmissive material; a white back surface white-coated layer provided on a back surface of the light guide member body; a white front surface white-coated layer provided on a front surface of the light guide member body; a black front surface black-coated layer provided on a front surface of the front surface white-coated layer; and a light irradiation hole which is opened in the front surface black-coated layer and the front surface white-coated layer and through which the light guide member body is exposed.

A vehicle illumination device according to a second aspect of the invention includes: a light source; and a light guide member to which light from the light source is incident from an end face. The light guide member includes: a light guide member body made of a light transmissive material; a white back surface white-coated layer provided on a back surface of the light guide member body; a white front surface white-coated layer provided on a front surface of the light guide member body; a black front surface black-coated layer provided on a front surface of the front surface white-coated layer; and a light irradiation hole which is opened in the front surface black-coated layer and the front surface white-coated layer and through which the light guide member body is exposed.

A method for manufacturing a light guide member according to a third aspect of the invention, the method includes: a coating step of coating a back surface and a front surface of a light guide member body made of a light transmissive material with white and black to form a back surface white-coated layer, a front surface white-coated layer, and a front surface black-coated layer; and a laser step of emitting a laser beam to form a light irradiation hole which is open in the front surface black-coated layer and the front surface white-coated layer and through which the light guide member body is exposed, after the coating step.

According to the above-described configuration, the front surface white-coated layer, the front surface black-coated layer, and the back surface white-coated layer are formed using the coated layers, and thus, it is possible to form an extremely thin layer. Thus, the light guide member has a thickness which is the sum of a thickness of the light guide member body and thicknesses of the front surface coated layers and the back surface coated layers, which are very thin as compared with the thickness of the light guide member, and thus, forms an extremely thin structure.

### BRIEF DESCRIPTION OF DRAWINGS

FIG. 1 is a cross-sectional view of a light guide member illustrating a first embodiment of the invention;

FIG. 2 is an enlarged cross-sectional view of a periphery of a light irradiation hole of the light guide member illustrating the first embodiment of the invention;

FIGS. 3A, 3B and 3C are cross-sectional views of manufacturing processes of the light guide member illustrating the first embodiment of the invention;

FIG. 4 is a cross-sectional view of an installation state of a vehicle illumination device illustrating a second embodiment of the invention; and

FIG. 5 is a cross-sectional view of the vehicle illumination device illustrating the second embodiment of the invention.

### DETAILED DESCRIPTION

Embodiments of the invention will be described below with reference to the drawings.

### First Embodiment

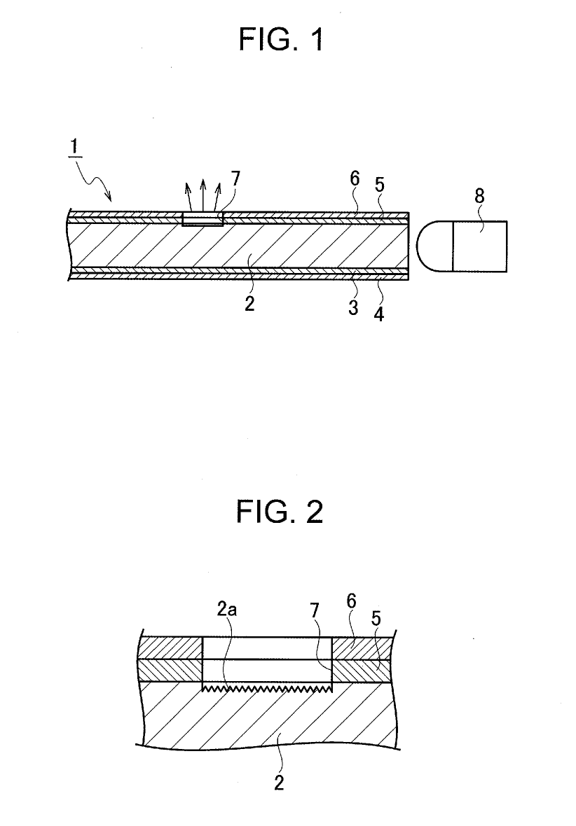

FIGS. 1 to 3C illustrate a first embodiment of the invention. As illustrated in FIG. 1, a light guide member 1 includes: a light guide member body 2; a white back surface white-coated layer 3 provided on a back surface of the light guide member body 2; a black back surface black-coated layer 4 provided on a back surface of the back surface white-coated layer 3; a white front surface white-coated layer 5 provided on a front surface of the light guide member body 2; and a black front surface black-coated layer 6 provided on a front surface of the front surface white-coated layer 5.

The light guide member body 2 is formed in a flat plate shape using a light transmissive material (for example, an acrylic material). The back surface white-coated layer 3, the back surface black-coated layer 4, the front surface white-coated layer 5, and the front surface black-coated layer 6 are provided on the entire front and back surfaces of the light guide member body 2.

A light irradiation hole 7 is opened in the front surface black-coated layer 6 and the front surface white-coated layer 5. The light guide member body 2 is exposed to the outside only at a position where the light irradiation hole 7 is formed on a side of the front surface of the light guide member 1. The light irradiation hole 7 is formed in a desired hole shape at a position (one or a plurality of positions) that is desirably irradiated with light from the light guide member 1. As illustrated in FIG. 2, the front surface of the light guide member body 2 exposed from the light irradiation hole 7 is formed in an uneven shape to form a light scattering layer 2a.

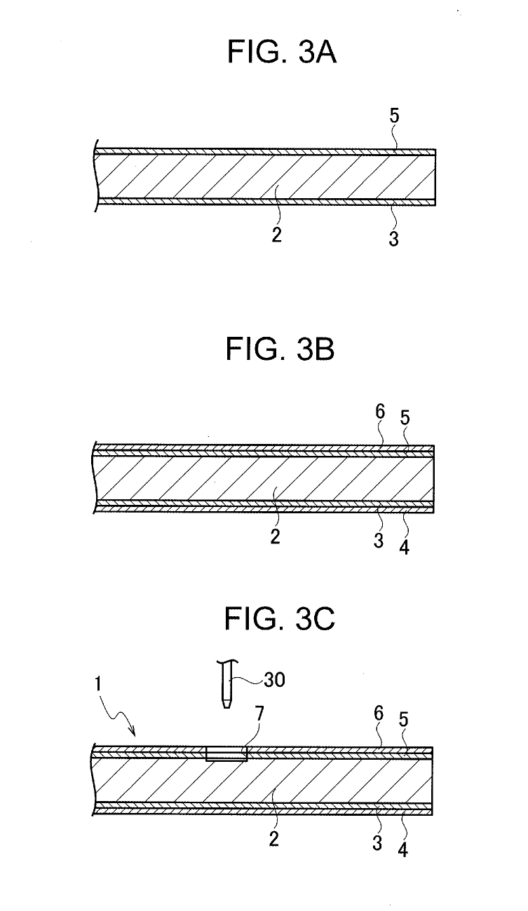

Next, a method for manufacturing the light guide member 1 will be described. First, a coating process is performed on the light guide member body 2. Specifically, white coating is performed on the back surface and the front surface of the light guide member body 2 to form the back surface white-coated layer 3 and the front surface white-coated layer 5 as illustrated in FIG. 3A. Next, black coating is performed from above the respective layers of the back surface white-coated layer 3 and the front surface white-coated layer 5 to form the back surface black-coated layer 4 and the front surface black-coated layer 6 as illustrated in FIG. 3B.

Incidentally, a coating process different from the above-described process may be performed. First, white coating and black coating are performed on the back surface of the light guide member body 2 to form the back surface white-coated layer 3 and the back surface black-coated layer 4. In a subsequent step or previous step, while coating and black coating may be performed on the front surface of the light guide member body 2 to form the front surface white-coated layer 5 and the front surface black-coated layer 6.

Next, an upper side of the front surface black-coated layer 6 is irradiated with a laser beam from the laser irradiation part 30 to shave the front surface black-coated layer 6 and the front surface white-coated layer 5, thereby forming the light irradiation hole 7 as illustrated in FIG. 3C. The laser beam is emitted to a depth at which the front surface of the light guide member body 2 below the front surface white-coated layer 5 is partially shaved. As illustrated in FIG. 2, the light scattering layer 2a having the uneven shape is formed on the front surface of the light guide member body 2 exposed from the light irradiation hole 7 by the laser beam. The manufacturing process is completed in this manner.

When light from an LED illumination unit 8, which is a light source, is incident from one end face of the light guide member 1 manufactured in this manner, the incident light advances inside the light guide member body 2 while being reflected at a boundary between the front surface white-coated layer 5 and the back surface white-coated layer 3 arranged on the front and back surfaces of the light guide member body 2. Then, the light is emitted to the outside through the light irradiation hole 7 (the front surface of the light guide member body 2 without the front surface white-coated layer 5 formed thereon). Since the front surface of the light scattering layer 2a formed in the light irradiation hole 7 has the uneven shape, more light is emitted in a wider range than the case of a flat surface due to diffuse reflection or light scattering.

As described above, the front surface white-coated layer 5, the front surface black-coated layer 6, the back surface white-coated layer 3, and the back surface black-coated layer 4 are formed using the-coated layers so that it is possible to form an extremely thin layer. Thus, the light guide member 1 has a thickness which is the sum of a thickness of the light guide member body 2 and thicknesses of the four coated layers, which are extremely thin as compared with the thickness of the light guide member body 2, and thus, forms an extremely thin structure. Therefore, the light guide member is optimum for a flat vehicle illumination device. In addition, the light guide member 1 is lightweight and has high flexibility by using the material such as acrylic that is lightweight and excellent in flexibility as the light guide member body 2.

In this embodiment, the coated layer of the light guide member 1 is constituted by the four layers of the front surface white-coated layer 5, the front surface black-coated layer 6, the back surface white-coated layer 3 and the back surface black-coated layer 4, but the back surface black-coated layer 4 can be omitted. If the back surface black-coated layer 4 is omitted, the structure can be made thinner. However, it is advantageous to provide the back surface black-coated layer 4 in terms of an increase in light amount of emitted light since a light reflection surface is also formed at a boundary between the back surface white-coated layer 3 and the back surface black-coated layer 4.

Since the front surface of the front surface black-coated layer 6 of the light guide member 1 can be formed as a design surface, there is no need to additionally provide the design member on a light-emitting side, and it is possible to form the extremely thin structure even from this point.

The light irradiation hole 7 of the light guide member 1 can be formed by forming the opening in the front surface black-coated layer 6 and the front surface white-coated layer 5, and thus, can be produced by laser irradiation as in this embodiment. Therefore, the degree of freedom of an opening shape is high, and a delicate opening shape can be formed.

### Second Embodiment

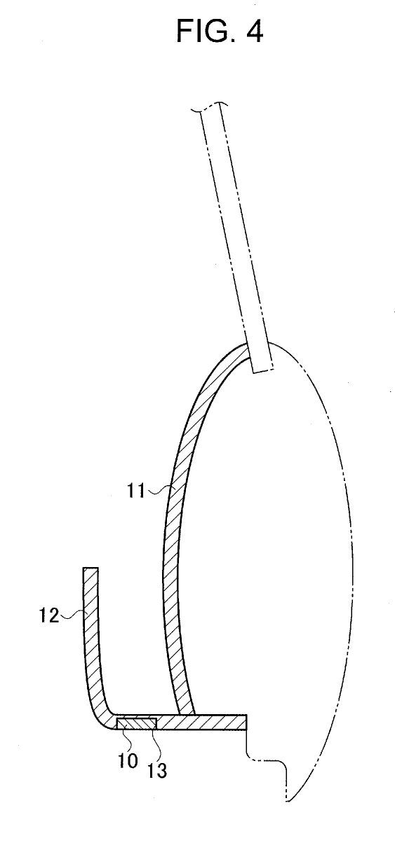

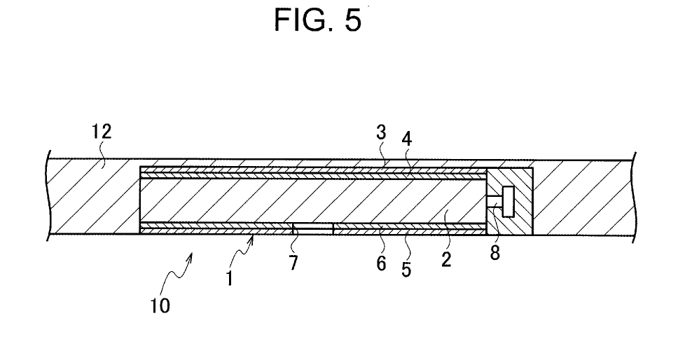

FIGS. 4 and 5 illustrate a second embodiment of the invention. The second embodiment is a vehicle illumination device 10 using a light guide member 1. The vehicle illumination device 10 is a foot area illumination of a vehicle. Details will be described hereinafter.

As illustrated in FIG. 4, a door pocket 12 is provided in a door trim 11 of the vehicle. A concave portion 13 is formed in a bottom portion of the door pocket 12. The vehicle illumination device 10 is arranged in this concave portion 13. As illustrated in FIG. 5, the vehicle illumination device 10 is packaged integrally with the light guide member 1 and an LED illumination unit 8 serving as a light source. Since the configuration of the light guide member 1 is the same as that of the first embodiment, the same constituent parts will be denoted by the same reference signs, and redundant descriptions will be omitted. A light irradiation hole 7 of the light guide member 1 is arranged so as to face downward. A front surface black-coated layer 6 of the light guide member 1 also serves as a design surface.

In a door-closed state, the vehicle illumination device 10 illuminates a floor at a feet area of a passenger at the time of lighting. As a result, assistance is made at the time of looking for a lost object, getting on or off of a passenger. In a door-open state, the vehicle illumination device 10 illuminates a ground below a released door at the time of lighting. This assists the passenger to get on and off.

Since the front surface black-coated layer 6 of the light guide member 1 also serves as the design surface in this embodiment, the vehicle illumination device 10 has a structure that is extremely thin. Incidentally, a design member (not illustrated) may be additionally provided on a side of a front surface of the front surface black-coated layer 6 of the light guide member 1. In that case, it is necessary to additionally form a light irradiation hole in the design member.

Although the case in which the vehicle illumination device 10 is applied to the foot area illumination of the vehicle has been described in the second embodiment, the vehicle illumination device 10 can be applied to an indirect illumination such as a roof of the vehicle, an illumination (direct illumination) indicating positions of various grips or the like, a pocket illumination (direct illumination) to illuminate the inside of a pocket, a personal illumination, and the like. In particular, the invention is optimum for a plate where only a narrow space can be secured as an installation space of the vehicle illumination device 10.

In the embodiments, the front surface and the back surface of the light guide member body 2 or the like are relative expressions, and the description has been given using a surface in which the light irradiation hole 7 is opened as the front surface.

What is claimed is:

1. A light guide member comprising:
a light guide member body made of a light transmissive material;
a white back surface white-coated layer provided on a back surface of the light guide member body;
a white front surface white-coated layer provided on a front surface of the light guide member body;
a black front surface black-coated layer provided on a front surface of the front surface white-coated layer; and
a light irradiation hole which is opened in the front surface black-coated layer and the front surface white-coated layer and through which the light guide member body is exposed.

2. The light guide member according to claim 1, further comprising
a black back surface black-coated layer provided on a back surface of the back surface white-coated layer.

3. The light guide member according to claim 1, further comprising
a light scattering layer having an uneven shape on the front surface of the light guide member body exposed through the light irradiation hole.

4. A vehicle illumination device comprising:
a light source; and
a light guide member to which light from the light source is incident from an end face,
wherein the light guide member comprises:
a light guide member body made of a light transmissive material;
a white back surface white-coated layer provided on a back surface of the light guide member body;
a white front surface white-coated layer provided on a front surface of the light guide member body;
a black front surface black-coated layer provided on a front surface of the front surface white-coated layer; and
a light irradiation hole which is opened in the front surface black-coated layer and the front surface white-coated layer and through which the light guide member body is exposed.

5. The vehicle illumination device according to claim 4, wherein
the light guide member further comprises a black back surface black-coated layer provided on a back surface of the back surface white-coated layer.

6. A method for manufacturing a light guide member comprising:
a coating step of coating a back surface and a front surface of a light guide member body made of a light transmissive material with white and black to form a back surface white-coated layer, a front surface white-coated layer, and a front surface black-coated layer; and
a laser step of emitting a laser beam to form a light irradiation hole which is open in the front surface black-coated layer and the front surface white-coated layer and through which the light guide member body is exposed, after the coating step.
